(19) United States
(12) Patent Application Publication
(10) Pub. No.: US 2024/0379970 A1
(43) Pub. Date: Nov. 14, 2024

(54) ADDITIVE INDUCED ELECTRODE CRACK MITIGATION

(71) Applicant: Alliance for Sustainable Energy, LLC, Golden, CO (US)

(72) Inventors: Carlos Manuel BAEZ-COTTO, Littleton, CO (US); Michael Joseph ULSH, Broomfield, CO (US); Scott Alan MAUGER, Arvada, CO (US)

(21) Appl. No.: 18/661,106

(22) Filed: May 10, 2024

Related U.S. Application Data
(60) Provisional application No. 63/501,249, filed on May 10, 2023.

(51) Int. Cl. H01M 4/86; H01M 4/88; H01M 4/92; H01M 8/10; H01M 8/1004; H01M 8/1018

(52) U.S. Cl. CPC H01M 4/8663; H01M 4/8828; H01M 4/92; H01M 8/1004; H01M 8/1018; H01M 2008/1095

(57) ABSTRACT

Described herein, are devices and methods that introduce polymeric additives in catalyst layer ink formulations that mitigate catalyst layer cracking and increase electrochemical performance in electrochemical fuel cells, including hydrogen fuel cells.

### CROSS-REFERENCE TO RELATED APPLICATIONS

This application claims priority from U.S. Provisional Patent Application No. 63/501,249 filed on May 10, 2023, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Developing catalyst layers that could potentially power up heavy-duty vehicles will prompt new challenges to fuel cell manufacturing, such as cracks that may form during the fabrication of these thick catalyst layers. Propagation and evolution of these defects into more complex crack networks can lead to reduced performance over time due to excess water retention, pinhole formation and/or membrane degradation. While cracks in catalyst layers can also form as a result of chemical-mechanical degradation during fuel cell operation, it is important to prevent their formation during the fabrication stage as these pre-existing morphological defects can lead to premature fuel cell failure in accelerated stress tests.

### SUMMARY

Described herein, are devices and methods that introduce polymeric additives in catalyst layer ink formulations that mitigate catalyst layer cracking and increase electrochemical performance in electrochemical fuel cells, including hydrogen fuel cells.

In an aspect, provided is a catalyst ink comprising: a) a solvent; b) a catalyst; c) an ionomer; and d) a polymer additive, wherein the polymer additive decreases the formation of cracks in a catalyst layer when the catalyst ink forms the catalyst layer.

In an aspect, provided is a method comprising: i) providing a catalyst ink comprising: a) a solvent; b) a catalyst; c) an ionomer; and d) a polymer additive, ii) depositing the catalyst ink on gas diffusion media or a polymer exchange membrane; and iii) solidifying the catalyst ink thereby forming a catalyst layer on the electrode or polymer exchange membrane; wherein the catalyst layer has reduced cracking due to the polymer additive. In some embodiments, the catalyst layer may also be formed on or proximate to an electrode.

In an aspect, provide is a device comprising: a) an anode; b) a cathode; c) a polymer exchange membrane (PEM) positioned between the anode and the cathode; and d) at least one catalyst layer positioned between the anode and the PEM, the cathode and the PEM, or both; wherein the catalyst layer comprises a polymer additive, wherein the polymer additive reduces the formation of cracks in the catalyst layer.

The catalyst ink may be useful for high catalyst loading, such as those for medium to heavy vehicle fuel cells, for example, the catalyst ink may have a concentration greater than 2 wt %, 3 wt %, 3.5 wt %, or optionally, 4 wt %.

In addition, the catalyst ink may provide increased electrochemical performance over catalyst layers formed without the addition of a polymer additive. For example, the increased electrochemical performance may be described by an E_{cell} increase greater than or equal to 1%, 2%, 5% or 10% at 1.5 A/cm² or an E_{cell} increase greater than or equal to 2%, 5%, 10% or 15% at 2 A/cm².

The catalyst ink layer may further increase the durability of the catalyst layer, for example, the reduction of cracking may remain present after 50 hours, 100 hours, or optionally 150 hours of chemical reaction time.

The polymer additive may have a wt % with respect to ionomer mass greater than or equal to 1%, 3% or 5% or selected from the range or 3% to 10%, 3% to 15%, 3% to 7% or 1% to 5%.

The polymer additive may be selected from the group of poly vinyl alcohol (PVA), poly vinyl butyral (PVB), poly acrylic acid (PAA), poly ethylene oxide (PEO), poly methyl methacrylate (PMMA), or a combination thereof.

As an example, the ionomer may comprise Nafion or a polyfluorosulfonic acid. PVA may be a useful additive for a a polyfluorosulfonic acid and a copolymer of PVA and PVB may be a useful additive for a polyfluorosulfonic acid, for example, HOPI.

The ion exchange membrane may be a cationic exchange membrane used as part of a membrane electrode assembly or as part of a polymer electrolyte membrane fuel cell. As an example, for H₂, the catalyst may be platinum-based, including platinum-based nanoparticles on carbon black, for example, Pt/HSC.

The described catalyst ink may substantially reduce the formation of cracks in the catalyst layer relative to a catalyst layer formed without the polymer additive, including for example, a 50%, 60%, 70%, 80%, 90%, 95% or 99% reduction in relative crack formation.

### BRIEF DESCRIPTION OF DRAWINGS

Some embodiments are illustrated in referenced figures of the drawings. It is intended that the embodiments and figures disclosed herein are to be considered illustrative rather than limiting.

FIGS. 1A-1D show chemical structures and molecular weights of the commercially available polymers used as additives: PAA (FIG. 1A), PEO (FIG. 1B), PMMA (FIG. 1C), and PVA (FIG. 1D). Bonds connecting to their respective end groups were purposely elongated to exclude them from the brackets surrounding the polymer repeating unit.

FIG. 2A provides representative CL rod-coated electrodes at a magnification of 500× and FIG. 2B provides quantified crack percentage values using our crack detection algorithm.

FIGS. 3A-3C show TEM fluorine maps for WRC (FIG. 3A), 5PEO (FIG. 3B), and 5PVA (FIG. 3C).

FIGS. 4A-4B provide stacked ATR-FTIR spectra for Nafion, PVA, and Nafion-PVA in the wavenumber range 3700-800 cm⁻¹ (FIG. 4A) and 1200-900 cm⁻¹ (FIG. 4B).

FIG. 5 illustrates a depiction of the hydrogen bond interaction of Nafion and PVA.

FIGS. 6A-6B provide overlayed FTIR spectra for PEO/PEO-Nafion (FIG. 6A) and PAA/PAA-Nafion (FIG. 6B) films.

FIGS. 7A-7C show XCT 3-D electron density reconstructions for WRC (left) and 5PVA (right): FIG. 7A: segmented Zernike phase contrast, FIG. 7B: absorption contrast, and FIG. 7C: threshold of ionomer aggregates.

FIG. 8 provides steady shear viscosity vs. shear rate plots for WRC and 5PVA CL inks.

FIG. 9 illustrates a potential mechanism of interaction proposed between the CL ink constituents.

FIG. 10 shows LD particle size distribution analysis for WRC and 5PVA.

FIG. 11 provides OM images of WRC and 5PVA inks sandwiched between glass slides. Propagation of these inks is captured in the wet columns, whereas the resulting microstructure can is noted on the dry columns.

FIGS. 12A-12F provide electrochemical characterization for WRC and 5PVA MEAs. H₂/air polarization curves for oversized 50 cm² at 80° C., 100% RH, 150 kPa (FIG. 12A) and 90° C., 40% RH, 250 kPa (FIG. 12B). FIG. 12C shows Oxygen-reduction reaction (ORR) mass activity (iₘ^{0.9V}) bar plots after three voltage recovery cycles. FIG. 12D provides electrochemical surface area values as a function of RH. Electrochemical impedance spectroscopy at 80° C., 100% RH, 150 kPa (FIG. 12E) and 90° C., 40% RH, 250 kPa (FIG. 12F).

FIG. 13 provides an example schematic illustrating the use of polymer additives to mitigate cracking.

FIGS. 14A-14C provide optical microscopy images for rod-coated catalyst layers with (FIG. 14A) no additive, (FIG. 14B) PVA-D1, and (FIG. 14C) PVA-D2, as described in Example 2.

FIG. 15 illustrates quantification of the area occupied by cracks between electrodes with and without PVA additive for the membranes described in Example 2.

FIG. 16 provides H₂/Air polarization curve at 80° C., 150 kPa, 100 RH for 5 cm² membrane electrode assemblies described in Example 2.

FIG. 17 provides H₂/Air polarization curve at 90° C., 250 kPa, 40 RH for 5 cm² membrane electrode assemblies described in Example 2.

FIG. 18 shows quantification of transport resistance for 5 cm² membrane electrode assemblies at 100 RH as described in Example 2.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or +1% of a specific numeric value or target. In some embodiments of the present invention, the term “about” is used to indicate an uncertainty limit of less than or equal to +1%, ±0.9%, ±0.8%, ±0.7%, ±0.6%, ±0.5%, ±0.4%, ±0.3%, ±0.2%, or +0.1% of a specific numeric value or target.

The provided discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

### Example 1-Impact of Polymeric Crack Mitigation of Fuel Cell Cathode Catalyst Layers

Cracks in catalyst layers (CLs) are a potential source of long-term failure in a fuel cell membrane electrode assembly (MEA). While modifications to the CL ink formulation can affect the degree of cracking, these changes can also lead to lower initial performance than their cracked analogues. In this work, we explored the use of polymeric additives to mitigate CL cracks. Small quantities of poly (acrylic acid), poly (ethylene oxide), poly (methyl methacrylate), or poly (vinyl alcohol)—5 wt. % relative to ionomer mass-were added to the ink prior to its final mixing stage. Poly (vinyl alcohol) rendered crack-free CLs, whereas the other materials exhibited similar crack percentages as the control electrode. Through a combination of transmission electron microscopy, X-ray computed tomography, and infrared spectroscopy, we ascribed the crack-mitigating mechanism of poly (vinyl alcohol) to its ability to hydrogen-bond with Nafion™, the ion conducting polymer binder in the catalyst ink.

### Introduction

In a fast and ever-growing demand for energy, where the world total consumption has doubled over the past 50 years, polymer electrolyte membrane fuel cells (PEMFCs) have emerged as an alternative renewable power source to fossil fuel-based technologies. Characterized by low operating temperatures and having water as their only byproduct, hydrogen-fuel based PEMFCs are an attractive platform for applications ranging from small portable electronic devices to transportation. However, affordability, fuel accessibility, and lifetime of PEMFCs remain an issue.

The core of a PEMFC is the membrane electrode assembly (MEA), typically composed of a polymer electrolyte membrane, catalyst layers, and gas diffusion layers. Much attention has been paid to cathode CLs, as the transport of gases (i.e., oxygen, nitrogen), protons, electrons, and water take place in this section. CLs typically contain platinum particles decorating a high-surface area carbon catalyst support. This layer is cast from a dispersion of the catalyst in a mixture of water, an organic solvent, and an ion-conducting polymer that also serves as a particle binder.

For medium- and heavy-duty vehicles, which currently account for almost one third of the greenhouse gas emissions in the US transportation sector, a CL electrode with Pt loadings on the order of 0.3 mg/cm² will likely be required to meet fuel cell efficiency and durability targets. The electrode thickness associated with this high loading will prompt new challenges to PEMFC manufacturing, such as cracks that may form during the fabrication of these thick catalyst layers. Immediately following ink coating onto the substrate, the ionomer-covered Pt/C catalyst particles are suspended in their respective solvent matrix. As evaporation proceeds, the air-solvent interface recedes toward the substrate. This effect generates a compressive stress on the film, which forces particles to pack into a porous network. Once the particles have fully compacted, the liquid begins to recede through the pores of the film leading to a surge in capillary stress between the particles. If this capillary stress is larger than the cohesive forces of the film, the film will react by releasing stress in the form of cracks. Propagation and evolution of these defects into more complex crack networks can lead to reduced performance over time due to excess water retention, pinhole formation and/or membrane degradation. While cracks in CLs can also form as a result of chemical-mechanical degradation during fuel cell operation, it is important to prevent their formation during the fabrication stage as these pre-existing morphological defects can lead to premature MEA failure in accelerated stress tests.

Judicious manipulation of the interactions among the active catalyst, the ionomer, and the solvent in this system is required to reduce cracks while maintaining the desired electrochemical performance. A common approach to alter the degree of cracking would be to tune catalyst particle-polymer interactions by changing the solvent environment. Previous experiments shows that higher water content in CL inks increased ionomer-Pt interactions and reduced the degree of ionomer aggregation, which in turn decreased transport resistance. Low water-content formulations, on the other hand, formed larger ionomer aggregates that increased oxygen transport resistance and decreased electrochemical performance at higher current densities. However, from an HDV manufacturing standpoint, water-rich CL inks render highly cracked electrodes whereas low water-content inks tend to minimize cracking, thus presenting a conundrum for maximizing performance and durability.

An alternative towards achieving this delicate balance can be sought through incorporation of additives to decouple performance and mechanical properties. Minimal amounts of these materials tune CL ink physicochemical properties to eliminate cracks and/or prevent detrimental MEA effects. Researchers have incorporated hydrophilic and hydrophobic organic additives, as well as inorganic materials, to enhance proton conductivity, control water removal, and reduce reactive radical species, respectively. However, variable levels of success were seen as certain chemical species induced or accelerated degradation mechanisms that shorten the fuel-cell lifetime. Furthermore, a lack of consistent fabrication, formulation, processing, and testing methodologies applied from study to study hinders mechanistic understandings and development of standardized guidelines for CL systems.

Even so, additives have proven successful in reducing cracks and/or stress development in other fields. As part of a parametric study to identify processing variables that affect cracks in aqueous alumina dispersions, it was discovered that film fracture resistance was linearly proportional to latex concentration. Addition of 0.15 wt % polymer increased the maximum crack-free film thickness by 115% (150 μm) relative to the control dispersion with no polymer (70 μm). It has also been found that stress development in calcium carbonate-cellulose suspensions varied depending on the type of additive used. In these studies, polymeric additives (in addition to the original cellulose binder) increased stress as they shrank and solidified in solution, whereas small organic molecules reduced residual stress by modifying physical properties of cellulose. Surfactants, on the other hand, lowered the surface tension of the film while lessening the magnitude of stress. Polymeric additives have also been used to enhance the tensile strength, thus improving fracture resistance, of concrete and soil systems. These examples show that additives can be a successful strategy to reduce cracks.

Other research has shown reduced cracks in CL electrodes of 0.1 mg Pt/cm² by incorporating propylene glycol into the CL ink. However, it is uncertain if this solvent formulation could sustain deformations during drying if the Pt loading were to increase by a factor of 3, as needed for heavy-duty vehicles. Presumably, higher temperatures and/or longer drying times would be required to fully remove this high boiling point solvent from the ink mixture. Furthermore, it is yet to be seen if the large amount of propylene glycol used (10% of the total ink mass) affects electrochemical performance. Nonetheless, it demonstrates that additives can be used to control CL crack formation.

Though there are obvious constraints when including a fourth chemical to an already complex ternary system, a low-level understanding of the role of each component in the CL should suffice to design crack-mitigating experiments in quaternary mixtures. As described herein, we systematically explored the crack-mitigating impact of polymeric additives in CL electrodes. A CL ink formulation comprised of 3.5 wt. % Pt on high-surface area carbon catalyst, an ionomer-to-carbon weight ratio of 1.0, and a 25-75 n-propanol-to-water mixture by weight as dispersion media were pre-mixed utilizing a high-shear rotor stator. 5 wt. % of polymeric additives relative to ionomer mass-which accounts for 1.8% of the total electrode mass-were then incorporated to the ink mixture, followed by a second stage of mixing via ball milling. This combination of mixing tools was utilized as they are efficient dispersion methodologies for CL ink concentrations that are relevant to roll-to-roll manufacturing. On the other hand, the relatively small amount of polymer additive was purposely chosen to avoid competitive adsorption between the ionomer and the additive and reduce the possibility of Pt poisoning in electrochemical testing. Preliminary screening of poly (vinyl alcohol) (PVA), poly (ethylene oxide) (PEO), poly (acrylic acid) (PAA), and poly (methyl methacrylate) (PMMA) were conducted on rod-coated electrodes with loadings of approximately 0.3 mg Pt/cm². CLs containing minimal amounts of PVA rendered crack-free coated surfaces. The mitigating mechanism of this polymer is rationalized in terms of an enhanced stress-bearing network capable of resisting cracking through distinct hydrogen bonds with the ionomer binder. Polarization curves show that the use of PVA does not impact MEA electrochemical performance when compared to the control electrode with no additive.

### Results

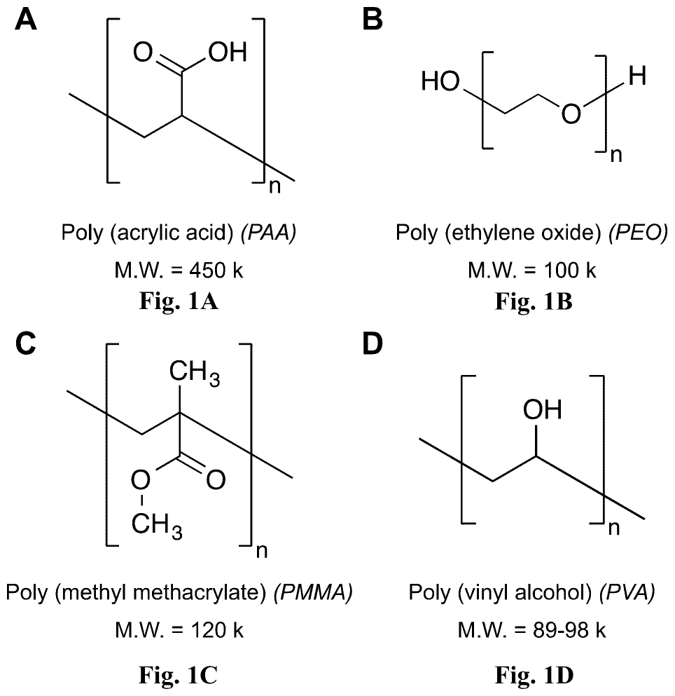

FIGS. 1A-1D depict the chemical structures and molecular weights (M_{w}) of the additives as described in this example. The selection of these commercially available polymers was based on the different functional groups as their repeating unit: PAA (FIG. 1A) is a macromolecule derived from carboxylic acids, PEO (FIG. 1B) is the linear form of the simplest epoxide, PMMA (FIG. 1C) belongs to the family of esters, and PVA (FIG. 1D) corresponds to the class of secondary alcohols. Whereas the average M_{w} values for PEO, PMMA, and PVA materials used are all close to 100,000 g/mol, the lowest M_{w} accessible for PAA in its solid form was 450,000 g/mol. Despite this difference in M_{w}, we expected these materials to nonetheless impart different physicochemical properties to the CL ink and its resulting electrode based on their chemical structure.

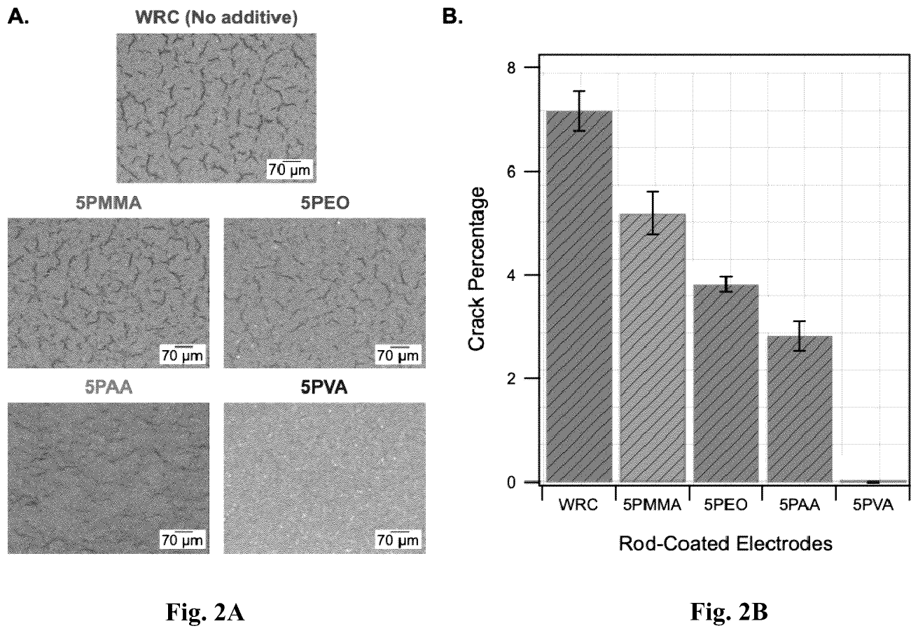

Both an ink with no additive, denominated as water-rich control (WRC), and those with 5 wt. % additives (5PAA, 5PEO, 5PMMA, and 5PVA) were rod coated onto Freudenberg H23C8 gas diffusion media using a wire-wound Mayer rod. The resulting coatings contained Pt loadings in the range of 0.256-0.272 mg Pt/cm². These electrodes are qualitatively similar in macroscopic appearance, depicting their characteristic black color and showing no signs of deformation (i.e., curling of the GDL) after drying. FIG. 2A shows representative optical micrographs for the 5 cases studied in this work at a 500× magnification. The electrodes were imaged in three different regions and then subjected to our crack detection algorithm, which calculated the area occupied by cracks in the CLs. The slight variation in in Pt loading did not affect the quantified average crack percentages. These values were transformed into a bar plot shown in FIG. 2B.

Inspection of WRC reveals a combination of linear, curved, and branched cracks that spread across the entire electrode surface. Our automated crack detection algorithm determined that these cracks occupy an average of 7.166±0.383% of the CL surface area. As described in a previous report, I-shaped (linear) cracks are expected to intersect with each other as they propagate through the gas diffusion electrode (GDE), resulting in the formation of U-shaped (curved) and Y-shaped (branched) cracks. A similar crack profile is noted for 5PMMA, with an average crack percentage of 5.194±0.413%. However, 5PMMA coatings contained several macro-scale clumps, which could be a potential indication of incompatibility between this polymer and the fixed formulation used for this study. Upon visual inspection, we found undissolved PMMA in the CL ink. As a consequence, this additive was no longer considered for additional experiments. In the case of 5PEO, average crack values of 3.818±0.147% were obtained. On the other hand, faint sinuous ripples characterized the surface morphology of 5PAA. If these defects were treated as cracks, then they would account for 2.825±0.282% of the CL. Due to the heterogeneity of this coating, 5PAA was ruled out as a crack-mitigating alternative. Interestingly, 5PVA CLs have a near-zero crack percentage of 0.01±0.00%. This dramatic change accounts for almost 100% reduction in cracks compared to the WRC. We also observed the presence of white speckles in the 5PVA micrograph. The surface quantification of this set showcase that cracks decrease in the following order: WRC>5PMMA>5PEO>5PAA>5PVA.

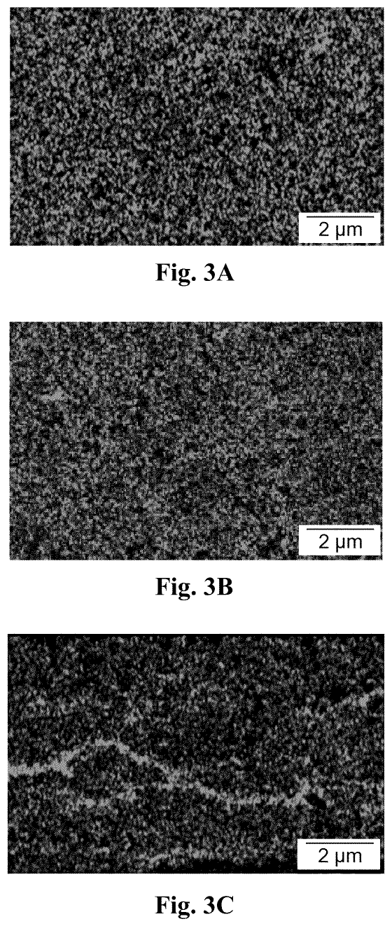

Given that polymer addition could impact molecular-level interactions between the Pt-embedded carbon catalyst and the ionomer, CL cross-sections were imaged using high-angle annular dark-field scanning transmission electron microscopy (HAADF-STEM) and energy-dispersive X-ray spectroscopy (EDS) maps were recorded for the same area with a resolution of 20 nm per pixel. For better contrast, fluorine is the only element highlighted in FIGS. 3A-3C. WRC shows evenly distributed C and F species. This same trend in catalyst and ionomer distribution is also noted in 5PEO electrodes. In the case of 5PVA, we visualize a unique accumulation of ionomer near the center of the micrograph. This elongated, linear-like structure was not observed in WRC nor 5PAA/5PEO loaded CLs. Interestingly, the carbon catalyst particles are evenly distributed throughout these distinct morphologies. Presumably, this unusual arrangement of Nafion might be the driving force behind the crack-mitigating behavior of 5PVA. Scanning electron microscopy (SEM) of 5PVA revealed a much thinner electrode thickness (6.3±0.5 μm) compared to WRC (7.6±1.0 μm), possibly suggesting that this densely packed ensemble forms through stronger intermolecular interactions between catalyst particles and PVA.

EDS Quantification for carbon, fluorine, and platinum are compiled in Table 1. The average values recorded for all three electrodes are nearly the same. Though 5PEO and 5PVA contain a slightly higher carbon percentage, this effect could be attributed to the hydrocarbon repeating units in their respective additives.

TABLE 1
Average element quantification for
WRC, 5PEO, and 5PVA using STEM-EDS.

| | STEM-EDS (at. %) | | |
|---|---|---|---|
| Sample | C | F | Pt |
| WRC | 97.1 | 2.0 | 0.9 |
| 5PEO | 98.1 | 1.1 | 0.8 |
| 5PVA | 97.7 | 1.3 | 1.0 |

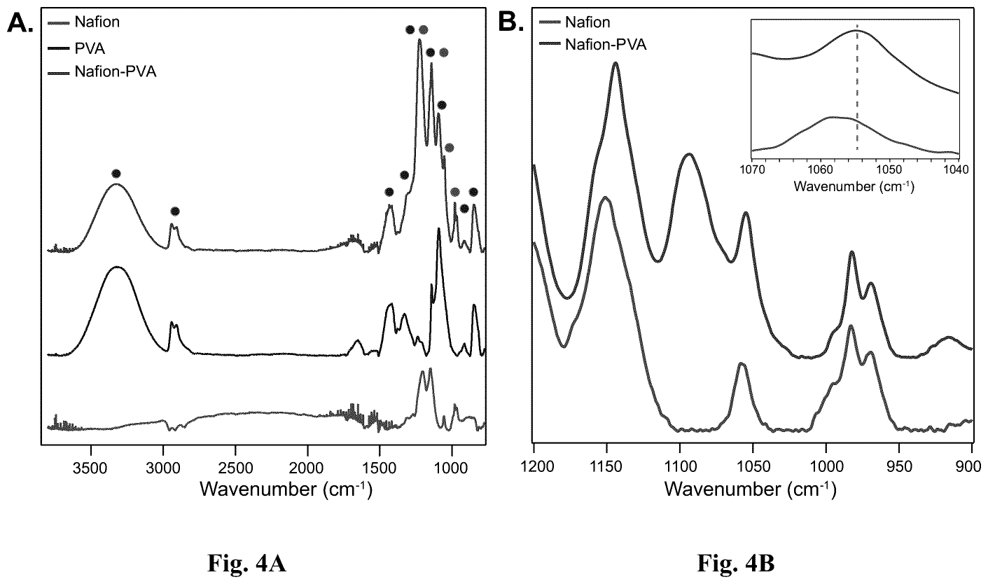

Based on the premise that PVA may govern the change in ionomer assembly and distribution through specific intermolecular forces, we sought to understand the interactions between them. Thin films of Nafion and PVA, as well as Nafion/PVA mixtures, were prepared from neat dispersions as described herein. The chemical bonding environment of these organic materials were elucidated via attenuated total reflectance-Fourier transform infrared spectroscopy (ATR-FTIR). FIG. 4A shows the absorption spectra for in the wavenumber range of 3750 to 750 cm⁻¹.

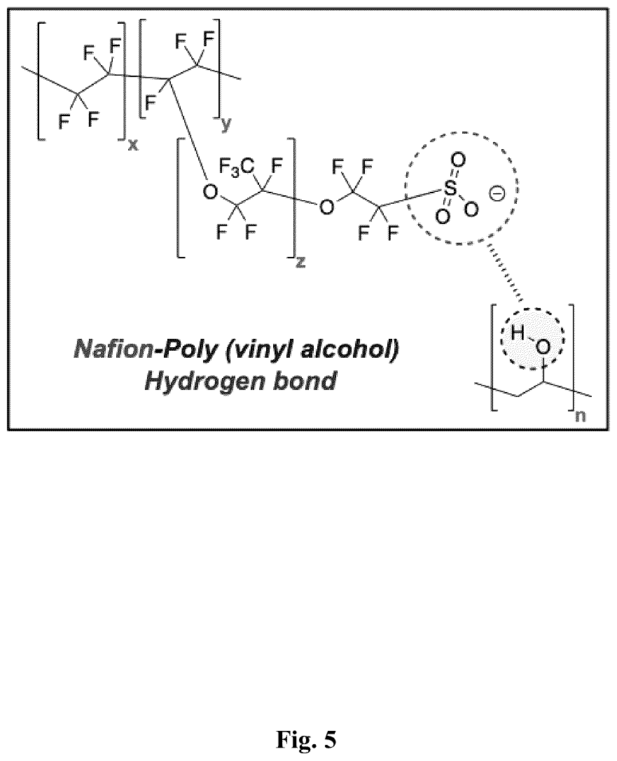

The bottom trace highlights signature groups of Nafion, such as CF₂ (853 cm⁻¹) and SO₃⁻ (1205, 1155, and 1064 cm⁻¹). The middle trace displays the characteristic OH (3305 cm⁻¹), CH₂ (2945, 2910 cm⁻¹), and C—O (1145, 1095 cm⁻¹) of PVA. Although the PVA utilized for this work is 99% hydrolyzed, it appears that some leftover of its synthesis precursor poly (vinyl acetate) is present, evidenced by the C═O band at 1654 cm⁻¹. All the aforementioned peaks are seen in the Nafion-PVA mixture spectrum, shown in the top trace. Circles are located on top of each peak to indicate which correspond to Nafion and PVA, respectively. New peaks are not observed, indicating no new chemical bonds have been formed. A closer inspection of the fingerprint region (FIG. 4B) of the prepared mixture reveals that the symmetric stretching vibration SO₃-band is slightly shifted to higher wavenumbers (1064 cm⁻¹) relative to the one observed for the Nation film (1053 cm⁻¹). This red shift effect is typically ascribed to hydrogen bond interactions between the sulfonate groups of Nafion and the hydroxyl moiety of PVA. FIG. 5 contains a representation of this chemical interaction. The so called Nafion-PVA complex is more notable in direct methanol fuel cell reports, where researchers have taken advantage of this polymeric interaction to fabricate novel membranes with increased proton conductivity and reduced methanol crossover. Others have made use of this particular effect to generate highly-transparent films with self-healing, anti-fogging, and frost-resisting properties. The FTIR spectra in publications by Li also share the 11 cm⁻¹ peak position shift of the SO₃⁻ Nafion band that we have observed here.

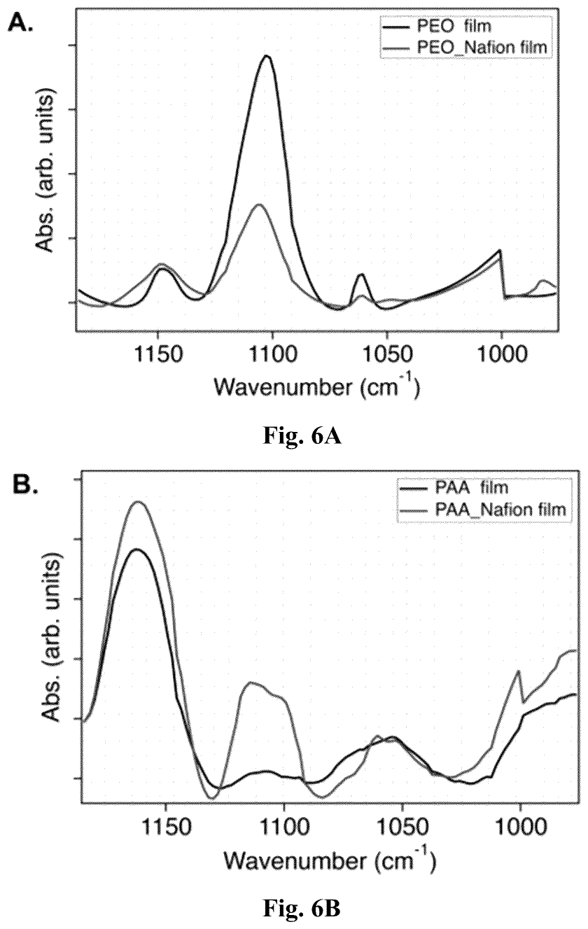

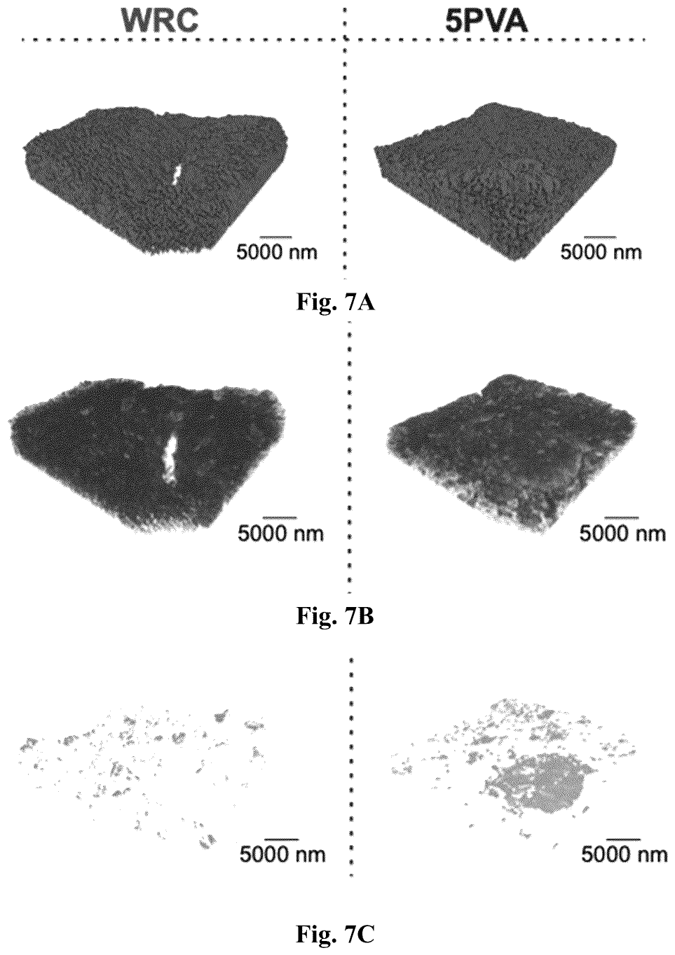

The same experiments were performed on PEO and PAA (FIGS. 6A-6B), the functional group analysis revealed the absence of new peaks and that pre-existing peaks did not shift in wavenumber position; hence, suggesting minimal interaction between the Nafion and the polymeric additive constituents. PAA-Nafion composites were considered as stable catalyst supports for PEMFC electrodes. As investigated by FTIR spectroscopy, a solution of these materials did not show any differences in peak positions. However, heating this mixture to 140° C. induced H-bond interactions that shifted the OH heteroatom region. Solutions of Nafion and PEO may also form interpolymer complexes through strong sulfonic acid-ether hydrogen bonds. It seems these interactions stem from the controlled pH in their respective suspensions. Specific methodologies seem to dictate intrinsic PEO-Nafion and PAA-Nafion interactions. This may be the main reason why we do not see such effects in other fabricated films described herein.

Complementary to STEM and ATR-FTIR analyses, three-dimensional reconstructions of WRC and 5PVA electrodes were generated via X-ray computed tomography (XCT) measurements of the catalyst layers. FIG. 7A contains the morphological composition of the electrode using the Zernike segmented phase contrast mode. More importantly, the crack in this sample can be visualized as a large 3 μm white gap that penetrates through the entire electrode structure. The observance and quantification of this depth feature could not be otherwise obtained through optical microscopy. Such an effect was not seen in 5PVA via any of the characterization methods.

FIG. 7B depicts the absorption contrast phases, which provides an alternate image refinement to differentiate low electron density materials (C) from those stained with the Cs⁺ ion exchange resin (Nafion). Under this specific view it is easier to appreciate that in WRC no neighboring particles are surrounding the area occupied by the crack, making this defect almost 5 μm in size.

By isolating the contributions from the ionomer in FIG. 7C, we can see the striking differences in Nafion agglomeration. While ionomer clusters are as big as 1 μm in WRC, the diameter of these clusters were observed to be up to 5 μm in 5PVA. Given that both electrodes share the same I/C, this apparent difference in ionomer content could stem from the threshold selected to generate these maps. It is unlikely that the small amount of PVA in this system-even if partially deprotonated by Cs—would be responsible of the higher quantity of ionomer seen in 5PVA. Nevertheless, the top view of the agglomerated Nafion in 5PVA is consistent with the band-like distribution captured in the TEM micrographs.

The PVA polymer additive may be plasticizing Nafion to mitigate cracks. Plasticizers are non-volatile, low molecular weight, and high boiling point materials that can modify the thermal and mechanical properties of a given polymer. By lowering the glass transition temperature (Tg) of binder polymers, this plasticizing effect can delay when polymer-plasticizer composites solidify in the drying process; thus, reducing the likelihood of stress development and cracks. Theoretically, the impact of a plasticizer on a polymer Tg can be estimated using the Gordon-Taylor equation:

$${T}_{g , Mix} = \frac{{w}_{Nafion} {T}_{g , Nafion} + k ( {w}_{P V A} ) {T}_{g , PVA}}{{w}_{Nafion} + k ( {w}_{P V A} )}$$

with

$$k = \frac{{ρ}_{Nafion} \cdot {T}_{g , Nafion}}{{ρ}_{P V A} \cdot {T}_{g , PVA}}$$

where w represents weight fraction, and p stands for polymer density. The values for each corresponding property are shown in Table 2.

TABLE 2
Physical properties of PVA on Nafion and their
respective composition in the CL ink.

| Polymer | T_{g} (° C.) | ρ (^{g}/_{mL}) | w |
|---|---|---|---|
| Nafion | 122.5 | 1.58 | 0.95 |
| PVA | 80 | 1.19 | 0.05 |

Given PVA loadings used in this study, the Gordon-Taylor equations predicts that Tg. Mix will be 120.60° C. Therefore, we believe this minimal 4.40° C. temperature decrease is not enough to treat the PVA in our work as a plasticizer. It is worth noting that for this estimation we have used the approximate midpoint of the range of Nafion's alpha transition, which is related to ionic transitions, as it is the transition temperature closest to the 80° C. drying temperature for these CLs.

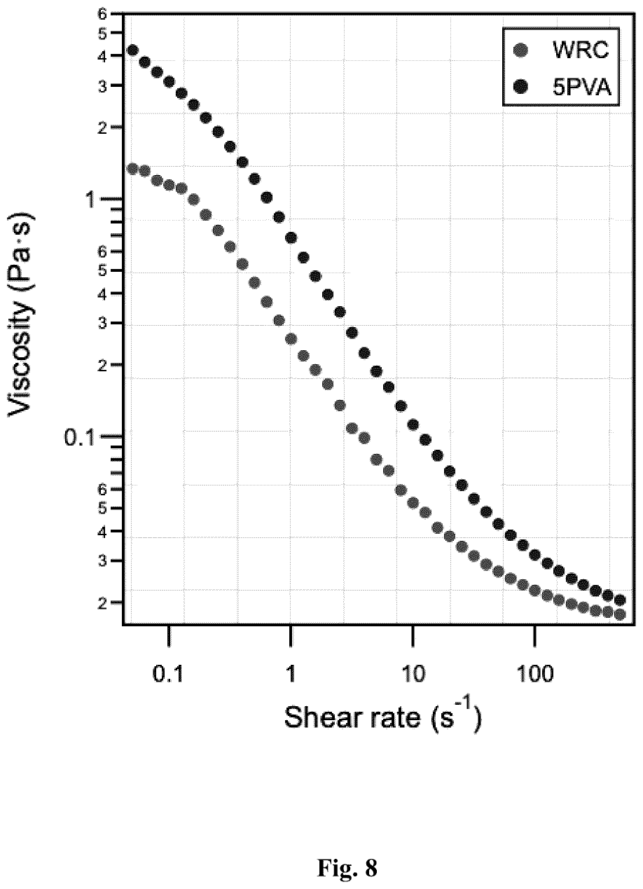

In complement to this equation, researchers rely on rheological measurements to assess changes in viscosity and/or elastic moduli with plasticizer addition. A cursory survey in literature shows that plasticizers lower the viscosity of polymers in solutions, generally due to a breakdown of the ordered polymer network or to weakening of inter- and intra-molecular interactions for both components. To verify these claims in our work, steady shear measurements for WRC and 5PVA CL inks were conducted. FIG. 8 depicts shear viscosity as a function of shear rate for WRC and 5PVA CL inks. While both samples exhibit shear thinning behavior, 5PVA does not possess a low-shear rate plateau. This effect could be indicative of a flocculated, stress-bearing network made up of weak intermolecular interactions. More importantly, the plot for 5PVA contains higher viscosity values across all shear rates relative to WRC, thus, further supporting that PVA is not plasticizing Nafion in this system.

Other considerations include the ability of this additive to hold particles together. Even though PVA possess an amphiphilic chemical structure, the low amount utilized for these experiments-5 wt. % relative to ionomer mass (1.8 wt. % of CL)—may not be enough to act as a binder. Furthermore, it is highly likely that the hydrophilic hydroxyl unit of PVA would deter from adhering to the hydrophobic catalyst surface. Instead, this polymer would be free in solution, where entropically-driven polymer-ionomer and polymer-solvent association would take place. This level of interaction was targeted by the addition of the polymer towards the end of the ink-fabrication recipe.

The H-bond interaction between Nafion and PVA could be used to explain the solution forming properties of this additive. Typically, solid PVA powder is bound by intermolecular PVA-PVA and intramolecular OH—OH H-bonds. When this polymer is mixed in the aqueous CL ink, its solubility would depend on replacing these interactions for PVA-solvent and PVA-Nafion H-bonds. As the hydrophilic solvent molecules and Nafion sulfonate headgroups insert into PVA following a pseudo-hydrolysis reaction, individual PVA chains could be isolated throughout the solution. Though it is uncertain what kind of structural configuration PVA chains will adopt following these interactions, other reports suggests that multiple PVA stranded assemblies-stabilized by hydrogen networks with water-will take place in aqueous solutions. Hence, in line with this notion, the F-rich bands seen in FIG. 3 may correspond to ionomer-covered particles H-bonded to helical-like PVA conformers.

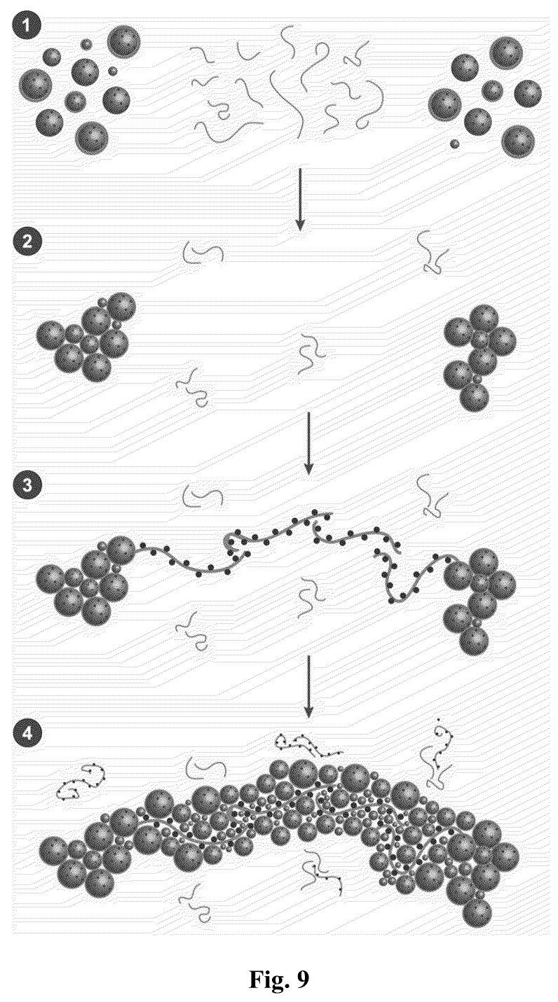

Based on our experimental findings, a potential mechanism of interaction among the CL ink constituents in FIG. 9. Specifically, we argue that these hydrogen bond interactions are facilitated by the solvent system in the Pt/C ink. Chemical incompatibility between the perfluorinated chains and the sulfonate headgroup of Nafion in a H₂O-rich environment will drive the hydrophobic backbones to assemble around the catalyst surface, while the dissociated SO₃″ molecules will point toward the water interface (Step 1). As particle contacts increase in solution, this ion conducting material would act as a binder through polymer-polymer interactions; hence, aggregation would take place (Step 2). Additional considerations-such as H₂O-nPA hydrogen-bond networks and H₃O⁺—SO₃ electrostatic interactions in this acidic media-would play a role in dictating particle-polymer-solvent interactions prior to addition of PVA. When PVA is added to the ink, as described with Nafion, it will self-arrange in a way that minimizes unfavorable CHₓ—H₂O contacts. Following the hydrophobic effect, the hydrocarbon end groups of PVA most likely will localize around the surface of catalyst particles (Step 3) while its hydrophilic repeating unit interacts with neighboring solvent and sulfonate molecules. Under the assumption that PVA will adopt an elongated helical pattern—with alternating hydroxy groups on the main hydrocarbon chain—this polymer could act as a backbone for ionomer-covered catalysts particles to attach around it through SO₃—HOC hydrogen bonds (Step 4). As PVA-Nafion H-bonds facilitate shorter intermolecular distances between catalyst particles, a thinner, densely packed electrode will form.

Additional considerations of this proposed mechanism pertain to its relation to crack mitigation. In theory, critical crack thickness (CCT) is defined as the energy required to form a crack relative to the energy gained in relieving stress from the film. A simplified approach to estimate the CCT to propagate a single crack in a film is given by:

$$C C T = ( \frac{{K}_{c}}{1.4 σ} ) \qquad Eq . ( 1 )$$

where Kₑ is the toughness of the film and σ refers to stress in the film. It has been previously calculated that Kₑ scales to the square root of latex concentration. However, due to the multi-component phenomena in our Pt/C inks, it is not straightforward to quantify these terms for WRC and 5PVA. Presumably, the H-bonded molecular architecture between Nafion and PVA can serve as physical crosslinks to increase K_{c} and enhance resistance to cracks. While the surface-adsorbing Nafion is keeping the Pt/C particles physically connected, the non-adsorbing PVA is forcing these aggregates to strongly adhere to its backbone. The larger agglomerated network formed as a result of these interactions could better withstand film stress, which in turn avoids morphological defects by increasing CCT.

These arguments could be further extrapolated into a more rigorous CCT equation. While this equation was developed for binder-free particulate dispersions and cannot be used to directly calculate CCT for catalyst inks, it provides a framework to qualitatively assess how chemical or physical changes to an ink will impact cracks. As shown in Equation 1, multiple variables were identified as key sources affecting CCT in addition to capillary pressure (Pₘₐₓ in this case):

$$C C T = 0.6 {{4 [ \frac{G M {ϕ}_{r c p} {R}^{3}}{2 γ} ]}^{1 / 2} [ \frac{2 γ}{- ( {P}_{max} ) R} ]}^{3 / 2} \qquad Eq . ( 2 )$$

such as particle shear modulus (G), particle coordination number (M), particle size (R), particle volume fraction at random close packing (φ), and the solvent-air interfacial tension (γ).

Under the assumption that Pₘₐₓ, γ, and G would not change between WRC and 5PVA (i.e., same processing conditions and materials), the parameters that dictate a CCT threshold in these systems would be M, R, and φ:

$$C C T ∝ \frac{{( M {ϕ}_{r c p} {R}^{3} )}^{1 / 2}}{{( - R )}^{3 / 2}} \qquad Eq . ( 3 )$$

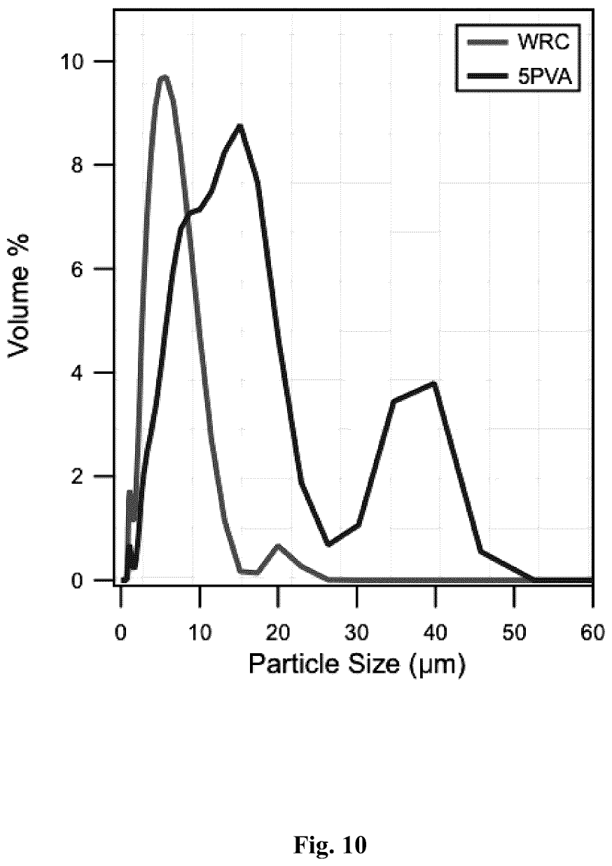

Given that the described system is mostly comprised of Pt/C clusters, differences in R between WRC and 5PVA could be explained in terms of agglomerate size. In this vein, feature agglomerate size values for these inks were obtained via laser diffraction (LD). FIG. 10 contains the averaged plots for WRC and 5PVA after three distinct measurements in the size range of 0-50 μm. Statistical size populations at the 10th, 50th, and 90th percentiles are listed on Table 3. WRC exhibits a trimodal distribution, starting with a low intensity shoulder at 1 μm. As we move to higher sizes, the instrument detects that most of the particles in this system are about 6 μm in diameter. Towards the end of this plot, we observe a slightly broad tail at 20 μm. Contrastingly, 5PVA behaves in a complex multimodal distribution. We observe a similar peak than in WRC at 1 μm, followed by two larger peaks approximately at 8 and 15 μm. Past these maximum size peaks, a much broader tail of lower intensity is seen between 32-48 μm. The unusually large particle sizes reported by LD may stem from instrument difficulties to accurately measure these irregularly shaped (i.e., non-spherical) Pt/C particles. Although ink particle size may not be representative of size values in the coated electrodes, we can qualitatively infer from these plots that 5PVA contains larger agglomerates than WRC, indicating an increase in R.

TABLE 3
Average particle size distribution for WRC and 5PVA using LD.

| | LD Particle Size Distribution (μm) | | |
|---|---|---|---|
| Sample | d (0.1) | d (0.5) | d (0.9) |
| WRC | 1.967 | 4.577 | 8.666 |
| 5PVA | 3.378 | 9.682 | 21.757 |

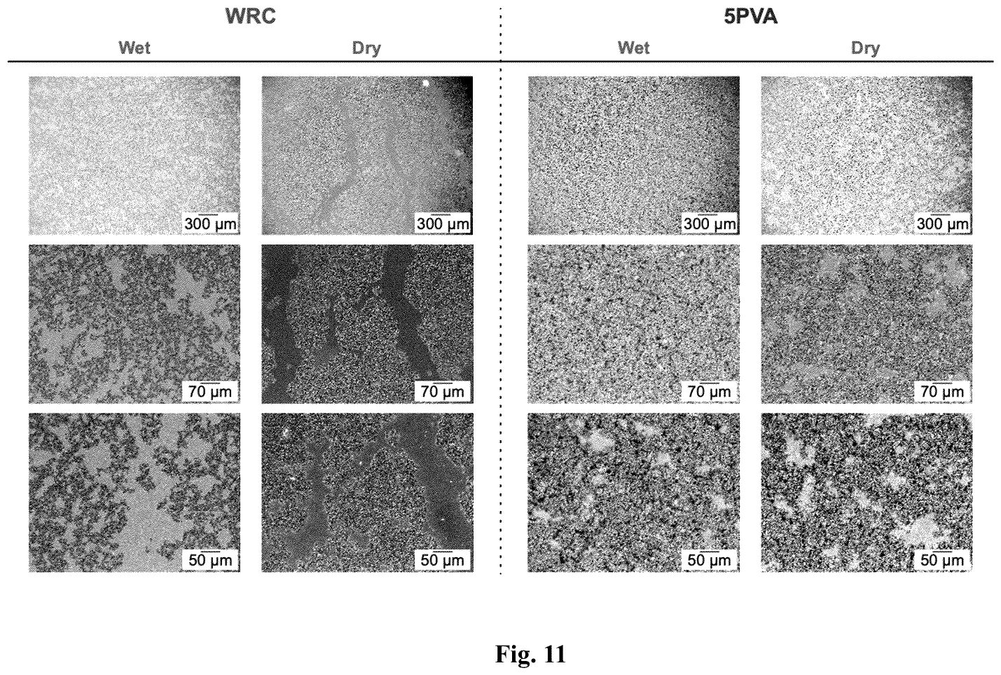

To support these findings with a secondary inspection method, we performed optical microscopy (OM) of WRC and 5PVA inks sandwiched between two glass slides. FIG. 11 shows micrographs of inks in their wet and dry stages at 100×, 300×, and 500× magnifications. As the ink flows in the glass slides, loosely attached agglomerates scattered in the case of WRC. Consequently, a large number of voids were captured in this sample. Once the solvent evaporated, these pockets exhibited a linear-like shape that closely resembled those of cracks in electrodes. The opposite scenario occurred for 5PVA, where little or no pores were seen as the ink flowed in between the microscope slides. The slightly darker images obtained of this system suggest that ink constituents share stronger interactions relative to WRC. Following its drying stage, 5PVA remained agglomerated in the form of fractal-like structures that spanned throughout the film. Due to the resolution of the microscope, it is hard to comment on other effects related to drying (i.e., particle deformation). These OM observations of WRC and 5VPA could also be correlated to M and φ. The more densely populated 5PVA would have more contact points between neighboring Pt/C particles. These numerous interparticle interactions (M) will build up larger agglomerated structures that will take more space in the studied field of view. As the agglomerates consolidate while drying, a porous ensemble with a rather high packing fraction (φ) will form.

A simplified rationale of the CCT equation in the context of these findings pertains to particle-particle contacts and how the resulting agglomerated structures suppress crack formation. In the presence of a polymer binder that can bring Pt/C particles together, the bond strength among these newly formed clusters will increase. As more catalyst builds onto this ensemble, the number of interparticle contacts and the overall agglomerate size will also go up. However, the mechanical integrity of the system will depend on the energy required to break these bonds. External forces (i.e., capillary pressure) could break such contacts simultaneously, generating multiple cracks throughout the electrode. This scenario closely resembles the failure mechanism taking place in WRC, where weak Van der Waals and repulsive electrostatic interactions predominate as the ink dries. Other factors-such as binder shrinkage-will also contribute to this stress development. On the other hand, when an additive that could further impart interparticle cohesion is incorporated to this system, opposing fracture mechanics are observed. Introducing H-bond forces to a higher extent than the typical solvent-ionomer and ionomer-ionomer in WRC will require more work to induce bond breakage and generate cracks in 5PVA. Hence, we suggest that the interplay between flocculated particles and H-bond networks are essential to prevent cracking in our 5PVA electrodes.

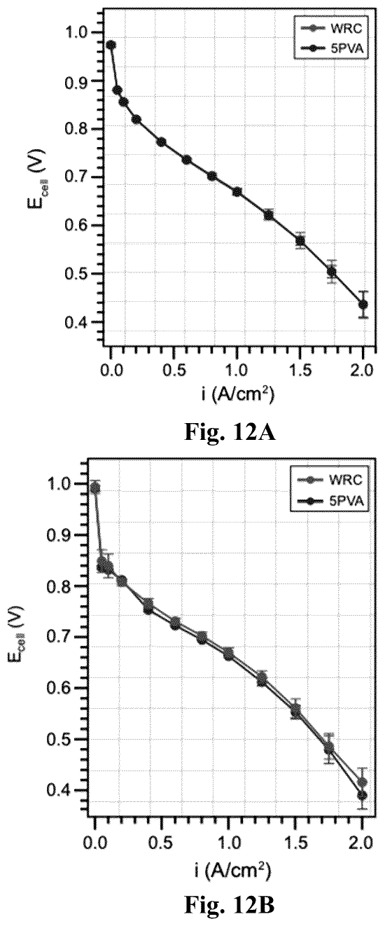

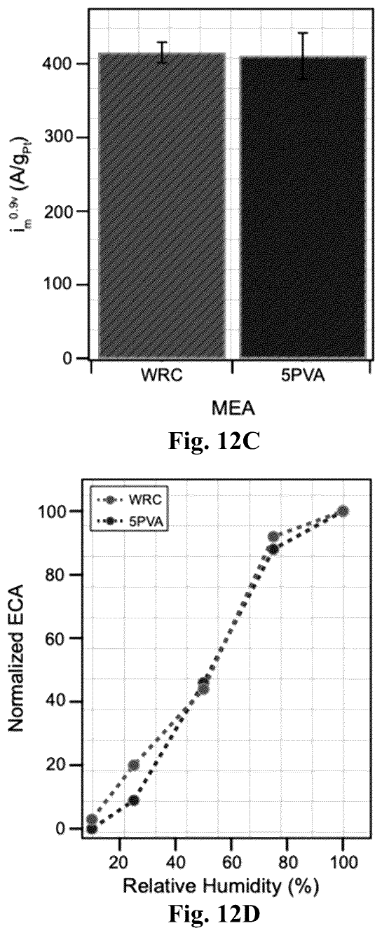

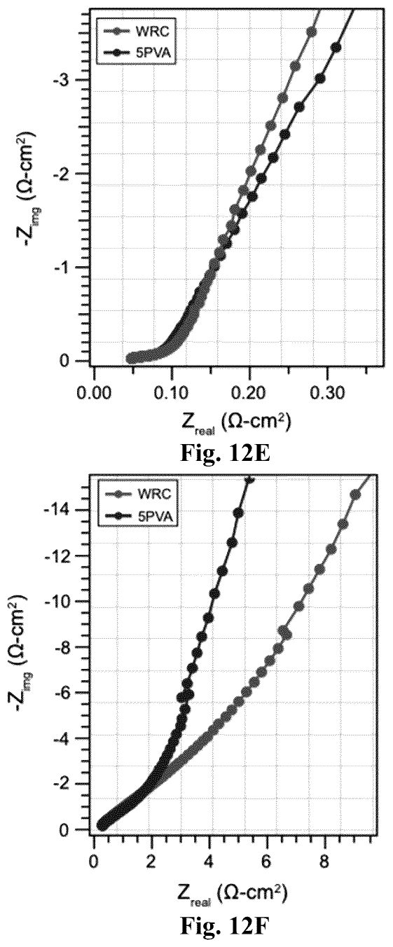

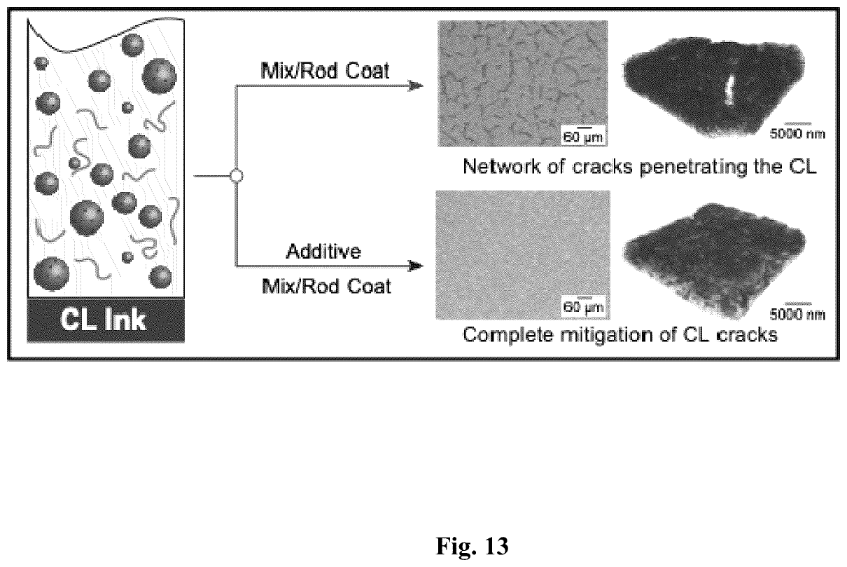

While our results show that PVA is able to effectively mitigate cracks in CLs it is also critical that it not diminish the electrochemical performance of the CLs. To assess the impact of this hydrophilic polymeric additive on CL electrochemical performance, WRC and 5PVA coated electrodes were fabricated into membrane electrode assemblies (MEAs). The Pt loadings for the electrodes used in this section ranged from 0.271 to 0.292 mg Pt/cm². FIGS. 12A-12B show averaged H₂/air polarization curves for two 50 cm² MEAs under dry (FIG. 12A) and wet (FIG. 12B) operating conditions. In general, the performance observed in these plots as a function of relative humidity (RH) are comparable to those on CLs prepared by spray and roll-to-roll coating. Regardless of the testing conditions both WRC and 5PVA show nearly identical behaviors. There are no differences in high-current density performance suggesting the changes in microstructure with the addition of PVA, as shown in FIG. 3, do not impact water management or oxygen transport.

The bar plot in FIG. 12C shows the oxygen-reduction reaction (ORR) mass activity (iₘ^{0.9V}) after three voltage recovery cycles. The measured values for iₘ^{0.9V} were 405.7 and 425.6 mA/mg_{Pt} for WRC and 388.8 and 432.8 mA/mg_{Pt} for 5PVA CL samples. This slight variation in iₘ^{0.9V} is within the range reported for MEAs of the same type. The normalized electrochemical active surface area (NECA) values in FIG. 12D were determined via CO stripping voltammetry at multiple RHs. Given that little to no changes are noted between WRC and 5PVA, these complementary advanced diagnostics further support that the CL microstructure of 5PVA-containing electrodes does not impact the Pt activity nor utilization.

Additionally, electrochemical impedance spectroscopy (EIS) measurements were carried to understand how ionomer agglomeration may affect the ionic (H⁺) conductivity in the CCL. FIG. 12E contains the Nyquist plot at 80° C./100 RH. Since both WRC and 5PVA spectra nearly overlap at high RH, we can infer that the PVA-Nafion complex is stable enough to withstand fabrication and operation conditions. On the contrary, a shorter R_{CL} is noted for 5PVA at intermediate frequencies in the 90° C./40% RH plot (FIG. 10F). Although these results suggest that 5PVA CLs might have slightly better H⁺ conductivity compared to the WRC at the RH, this effect could also be explained by the slight differences in electrode thickness measured via SEM. This set of electrochemical diagnostics highlight that insertion of minimal amounts of PVA can mitigate cracks—by creating a continuous ionomer network throughout the CL-without any loss in electrochemical performance.

### Conclusion

Described herein are four CL ink formulations that contained minimal quantities of commercially available polymeric additives. The crack mitigating behavior of the resulting electrodes increased in the order 5PMMA<5PEO<5PAA<5PVA. Insertion of PVA induced H-bond interactions with Nafion, which in turn generated agglomerated catalyst networks capable of resisting fracture mechanisms. Ultimately, none of the physical and chemical modifications induced by PVA negatively impacted MEA electrochemical performance. These results highlight how specific CL ink molecular-level interactions can tune electrode properties.

### Example 2-Additive Dispersion Pathway and its Relation to Electrochemical Performance

Materials—All materials and reagent grade solvents were used as received unless otherwise noted. High-surface area platinum on carbon catalyst TEC10E50E (Pt/HSC, 46.7 wt % Pt) was purchased from Tanaka Kikinzoku Kyogo. An alcohol based Nafion™ dispersion (D2020, 920 equivalent weight at 20%) from Ion Power was used as our polymer binder. Omnisolv® grade n-propanol (nPA), ultra-pure water (18.2Ω, Milli-Q® Advantage A10 Water Purification System), and poly (vinyl alcohol) (PVA; M_{w}=89,000-98,000 g/mol, 99% hydrolyzed) were obtained from Millipore Sigma.

Cathode CL ink preparation—The cathode catalyst ink was prepared by combining 50 g of Pt/HSC, ultra-pure water, D2020, and nPA into a 60 mL mixing vessel. As a safety precaution, both D2020 and nPA were added last to prevent a Pt-catalyzed combustion of this alcohol. These contents were mixed at 6,000 rpm for 20 min using the T 25 digital Ultra-Turrax® high-shear rotor stator (IKA). 20 g portions of the resulting ink were transferred to 30 mL glass jars, followed by incorporation of 5% PVA solutions relative to ionomer mass. In our first approach (PVA-DI), 0.33 wt. % of PVA was dispersed in a 33.22 wt. % nPA and 66.45 wt. % water combination. The second dispersion (PVA-D2) was comprised of 0.25 wt. % PVA, 4.99 wt. % Nafion, 36.41 wt. % nPA, and 58.35 wt. % water. These formulated recipes contained 3.5 wt % catalyst, an ionomer-to-carbon weight ratio of 1.00, and a water-to-alcohol weight ratio of 3 (75 wt % H₂O, 0.91 H₂O mole fraction). As a last step, 70 g of Glen Mills 5 mm zirconium oxide grinding media were added to this mixture prior to ball milling on a U.S. Stoneware jar mill roller at 20 speed units (˜60 rpm) for 20 h. Once mixing was completed, the inks were allowed to settle for 20 min before coating.

Rod-coating of cathode CL inks-Pt/C inks were coated at 22° C. utilizing five ½″×16″ wire wound lab rods (RD Specialties-mil diameter 75) on a Qualtech automatic film applicator (QPI-AFA6800). 3 mL of catalyst ink deposited on a Freudenberg H23C8 carbon gas diffusion media (Fuel Cell Store) were rod coated at a fixed average speed of 55 mm/s. These coated CLs were transferred to an oven and dried at 80° C.

MEA Fabrication-GDEs were hot-pressed together at 25 kg_{f} cm⁻² at 120° C. for 3 mins. Edge protection and mild hot-pressing conditions were used to minimize the occurrence of process-induced defects in the membrane and catalyst layer. PTFE gaskets were chosen to give ˜18% GDL compression given Freudenberg H23C8 gas diffusion media.

In-situ electrochemical performance-Fuel cell testing was performed on oversized 50 cm² MEAs using a customized Hydrogenics test station. The testing protocols applied to all the MEAs tested in this work consisted of an initial break-in procedure and voltage recovery (VR) cycles. The VR cycles were followed by polarization measurements in both H₂/O₂ and H₂/air. This loop was repeated three times to achieve peak beginning-of-life performance. After steady state polarization curves were measured at 80° C., 100% RH, 150 kPa, and 90° C., 65% RH, 250 kPa. H₂/N₂ EIS experiments were performed at several relative humidities to measure H⁺ conductivity. Effective H⁺ transport resistances were calculated from H₂/N₂ EIS spectra using the Open-Source Impedance Fitter tool.

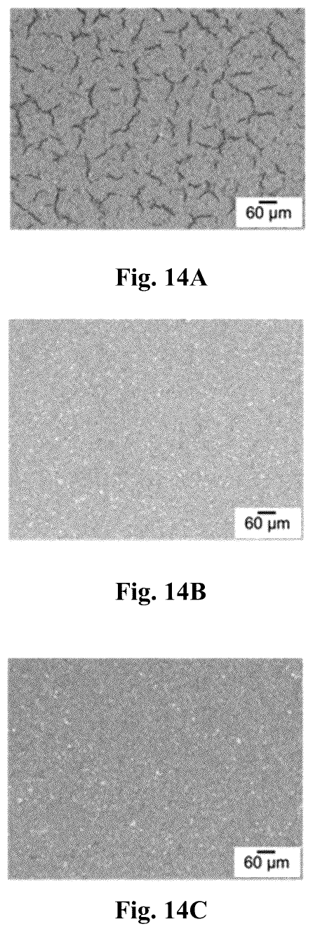

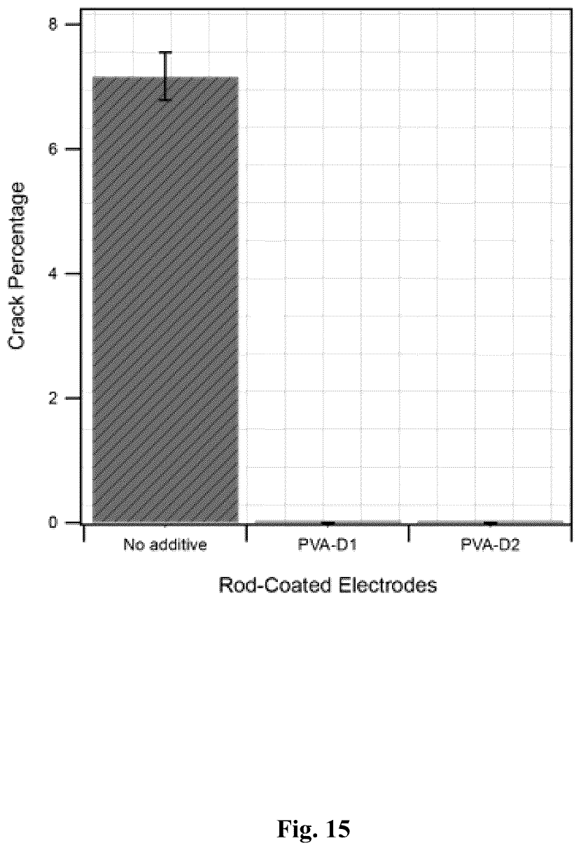

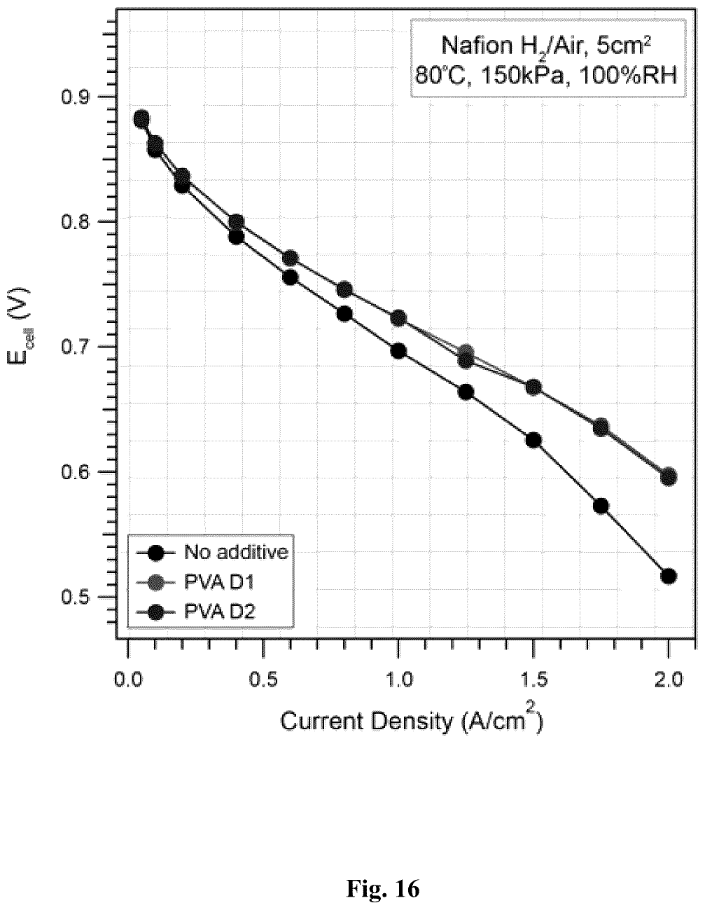

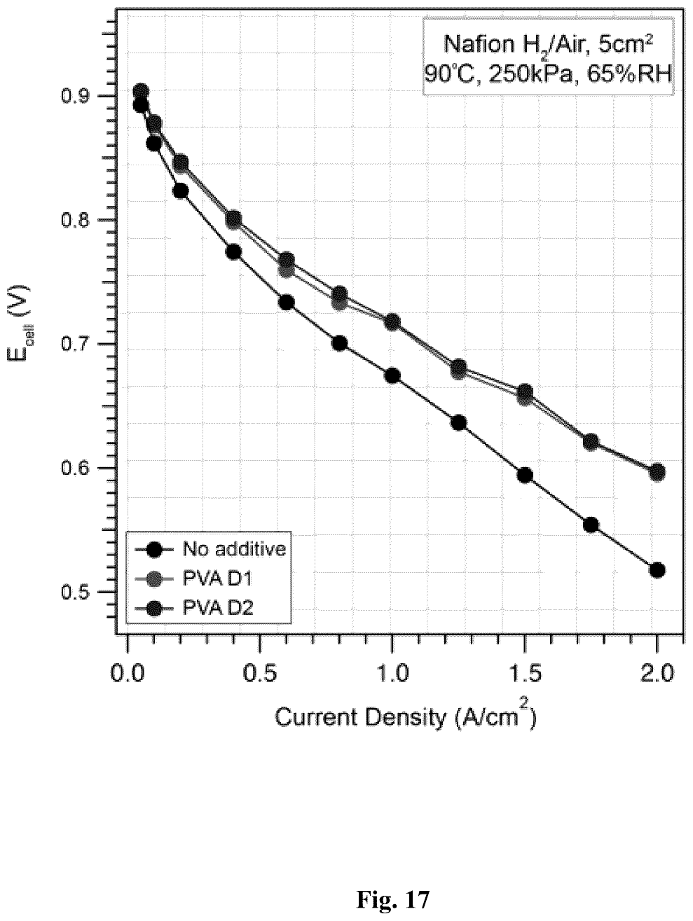

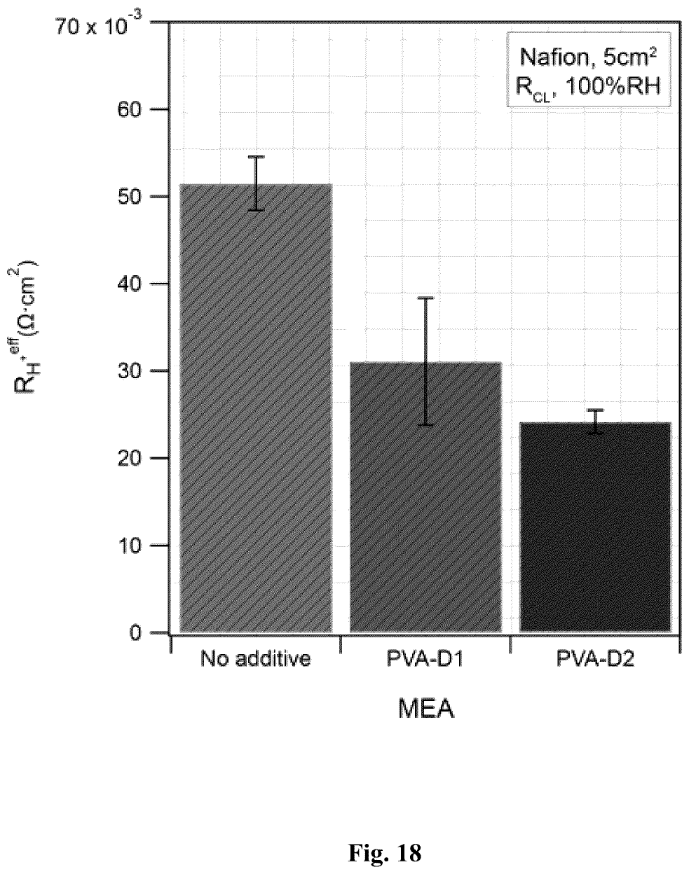

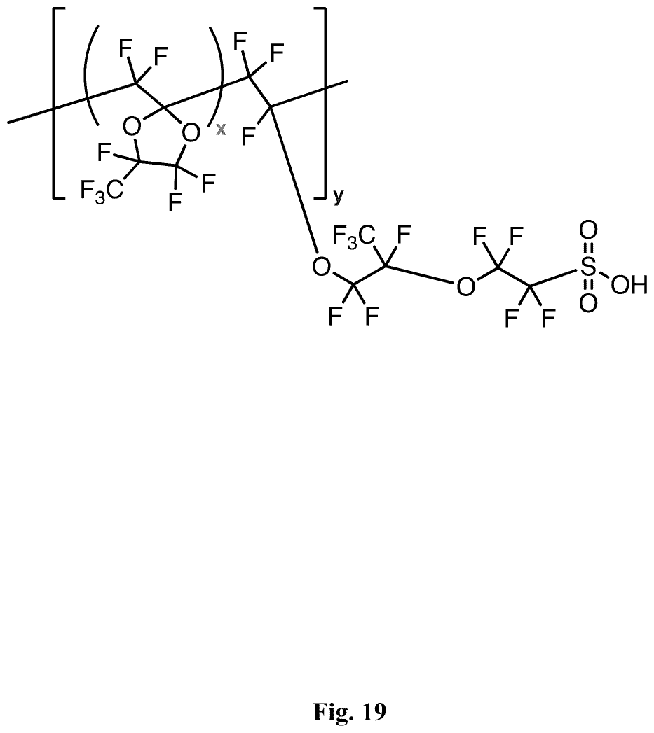

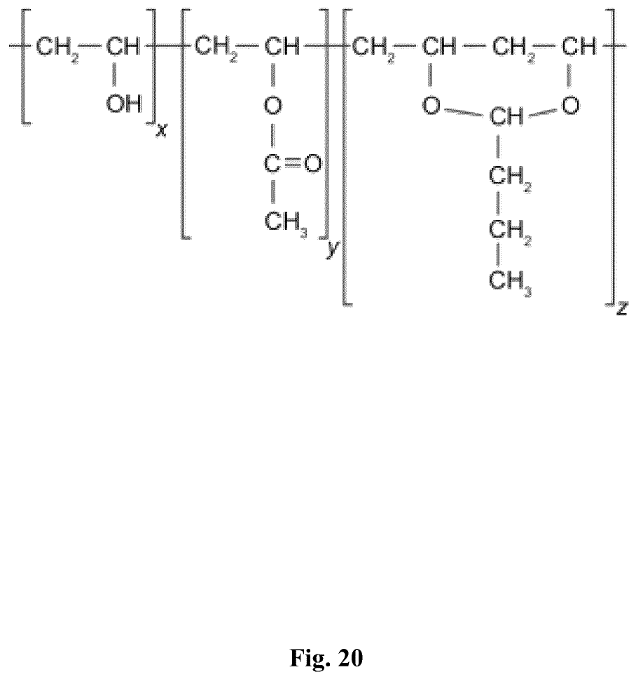

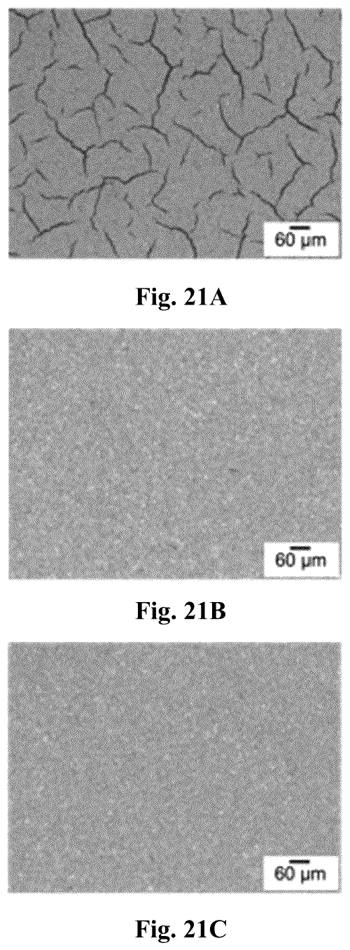

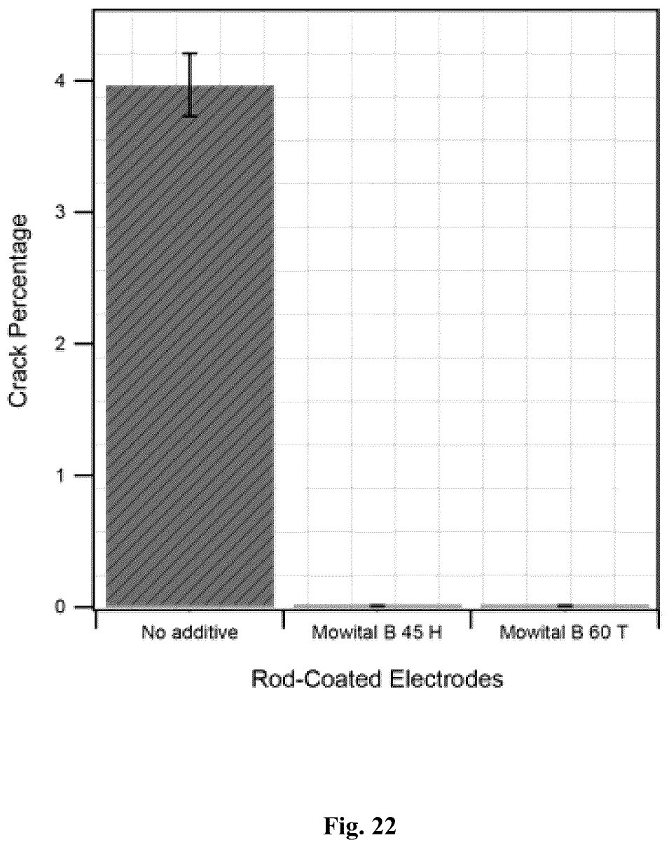

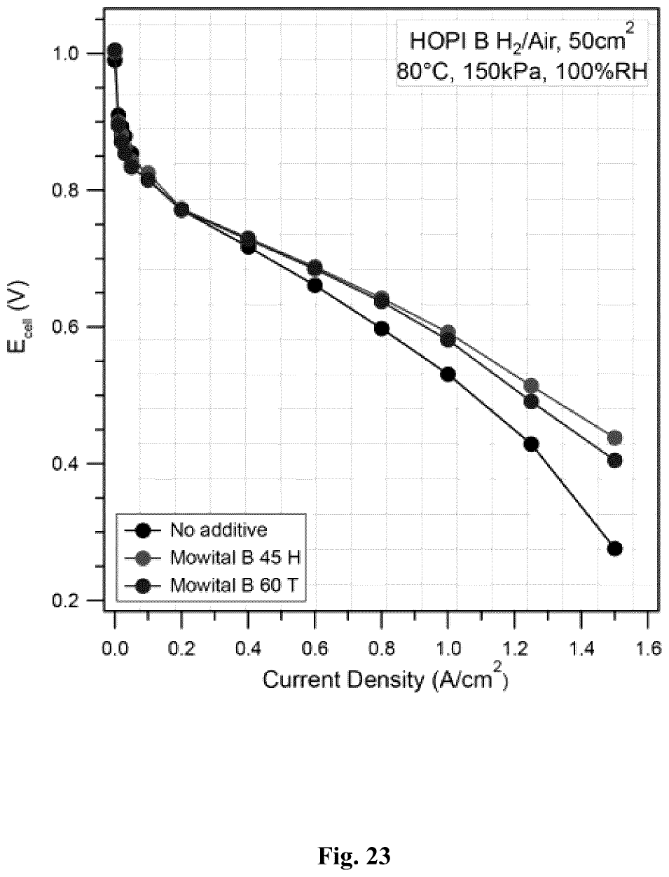

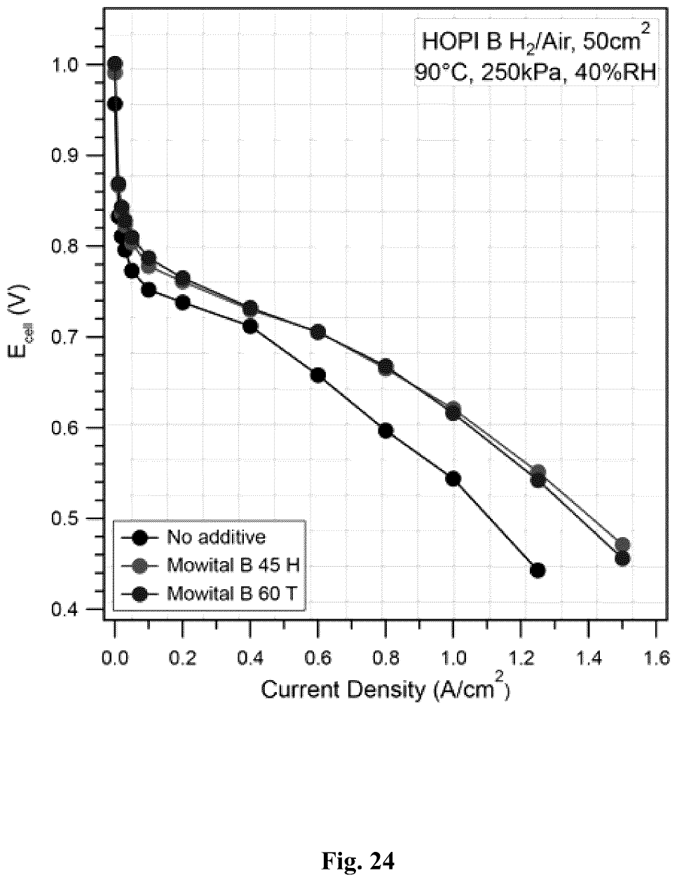

Results for the experiments described in Example 2 are provided in FIGS. 14-18 and Tables 4-5 (below). FIGS. 14A-14C provide optical microscopy images for rod-coated catalyst layers with (FIG. 14A) no additive, (FIG. 14B) PVA-DI, and (FIG. 14C) PVA-D2. FIG. 15 illustrates quantification of the area occupied by cracks between electrodes with and without PVA additive. FIG. 16 provides H₂/Air polarization curve at 80° C., 150 kPa, 100 RH for 5 cm² membrane electrode assemblies. FIG. 17 provides H₂/Air polarization curve at 90° C., 250 kPa, 40 RH for 5 cm² membrane electrode assemblies. FIG. 18 shows quantification of transport resistance for 5 cm² membrane electrode assemblies at 100 RH. PVA mitigates cracks and enhances electrochemical performance at higher current densities while facilitating a higher proton conductivity.

TABLE 4
Membrane electrode assembly voltage comparison at fixed
current densities between the control electrode (no additive)
and the electrode with either Dispersion 1 or Dispersion 2 of
poly (vinyl alcohol). The % increase column describes the
performance improvement imparted by these polymeric
additives, in addition to their crack-mitigating behavior.
80° C., 150 kPa, 100 RH H₂/Air polarization curves

| i (A/cm²) | V_{No additive} | V_{Additive} | % increase |
|---|---|---|---|
| 0.40 | 0.788 | 0.800 | 1.52 |
| 0.60 | 0.755 | 0.771 | 1.99 |
| 0.80 | 0.727 | 0.746 | 2.75 |
| 1.00 | 0.697 | 0.723 | 3.88 |
| 1.25 | 0.664 | 0.695 | 4.67 |
| 1.50 | 0.626 | 0.668 | 6.88 |
| 1.75 | 0.573 | 0.637 | 11.17 |
| 2.00 | 0.516 | 0.596 | 15.67 |

TABLE 5
Membrane electrode assembly voltage comparison at fixed
current densities between the control electrode (no additive)
and the electrode with either Dispersion 1 or Dispersion 2 of
poly (vinyl alcohol). The % increase column describes the
performance improvement imparted by these polymeric
additives, in addition to their crack-mitigating behavior.
90° C., 250 kPa, 65 RH H₂/Air polarization curves

| i (A/cm²) | V_{No additive} | V_{Additive} | % increase |
|---|---|---|---|
| 0.40 | 0.774 | 0.801 | 3.49 |
| 0.60 | 0.734 | 0.768 | 4.78 |
| 0.80 | 0.701 | 0.741 | 5.72 |
| 1.00 | 0.675 | 0.718 | 6.53 |
| 1.25 | 0.637 | 0.682 | 7.00 |
| 1.50 | 0.594 | 0.661 | 11.28 |
| 1.75 | 0.554 | 0.621 | 12.27 |
| 2.00 | 0.517 | 0.598 | 15.47 |

### Example 3-Incorporating Additional Polymeric Additives in Fuel Cell Cathode Catalyst Layers Containing HOPI B

Materials—All materials and reagent grade solvents were used as received unless otherwise noted. High-surface area platinum on carbon catalyst TEC10E50E (Pt/HSC, 46.7 wt % Pt) was purchased from Tanaka Kikinzoku Kyogo. A water-based HOPI B dispersion (925 equivalent weight at 10%) provided by Chemours was used as our polymer binder. Omnisolv® grade n-propanol (nPA), ultra-pure water (18.2Ω, Milli-Q® Advantage A10 Water Purification System), and poly (vinyl butyral) (Mowital B 45 H; 18-21 wt. % PVA, Mowital B 60 T; 24-27 wt. % PVA) were obtained from Kuraray America.

Cathode CL ink preparation—The cathode catalyst ink was prepared by combining 50 g of Pt/HSC, ultra-pure water, D2020, and nPA into a 60 mL mixing vessel. As a safety precaution, both D2020 and nPA were added last to prevent a Pt-catalyzed combustion of this alcohol. This formulated recipe contained 3.5 wt % catalyst, an ionomer-to-carbon weight ratio of 1.00, and a water-to-alcohol weight ratio of 0.33 (25 wt % H₂O, 0.53 H₂O mole fraction). These contents were mixed at 6,000 rpm for 20 min using the T 25 digital Ultra-Turrax® high-shear rotor stator (IKA). 20 g portions of the resulting ink were transferred to 30 mL glass jars, followed by incorporation of 5% solid Mowital polymeric additives relative to ionomer mass. To ensure effective interaction between the Pt/C ink and the newly added component, these samples were dispersed using a M3800 Bransonic ultrasonic bath sonicator for 10 min. As a last step, 70 g of Glen Mills 5 mm zirconium oxide grinding media were added to this mixture prior to ball milling on a U.S. Stoneware jar mill roller at 20 speed units (˜60 rpm) for 20 h. Once mixing was completed, the inks were allowed to settle for 20 min before coating.

Rod-coating of cathode CL inks-Pt/C inks were coated at 22° C. utilizing five ½″×16″ wire wound lab rods (RD Specialties-mil diameter 75) on a Qualtech automatic film applicator (QPI-AFA6800). 3 mL of catalyst ink deposited on a Freudenberg H23C8 carbon gas diffusion media (Fuel Cell Store) were rod coated at a fixed average speed of 55 mm/s. These coated CLs were transferred to an oven and dried at 80° C.

MEA Fabrication-GDEs were hot-pressed together at 25 kg_{f} cm⁻² at 120° C. for 3 mins. Edge protection and mild hot-pressing conditions were used to minimize the occurrence of process-induced defects in the membrane and catalyst layer. PTFE gaskets were chosen to give ˜18% GDL compression given Freudenberg H23C8 gas diffusion media.

In-situ electrochemical performance-Fuel cell testing was performed on oversized 50 cm² MEAs using a customized Hydrogenics test station. The testing protocols applied to all the MEAs tested in this work consisted of an initial break-in procedure and voltage recovery (VR) cycles. The VR cycles were followed by polarization measurements in both H₂/O₂ and H₂/air. This loop was repeated three times to achieve peak beginning-of-life performance. After steady state polarization curves were measured at 80° C., 100% RH, 150 kPa, and 90° C., 40% RH, 250 kPa.

The experiments described in Example 3 illustrate the efficacy of poly (vinyl butyral) (PVB or Mowital®) for crack mitigation in High Oxygen Permeability Ionomer (HOPI)-B. The chemical structure of HOPI-B is provided in FIG. 19 and the structure of PVB/Mowital is provided in FIG. 20. Experimental results for PVB additives in HOPI-B are provided in FIGS. 21-24 and Tables 6-7.

FIGS. 21A-21C provide optical microscopy images for rod-coated catalyst layers with (FIG. 21A) no additive, (FIG. 21B) Mowital B 45 H, or (FIG. 21C) Mowital B 60 T. FIG. 22 illustrates quantification of the area occupied by cracks between electrodes with and without Mowital additives. FIG. 23 shows H₂/Air polarization curve at 80° C., 150 kPa, 100 RH for 50 cm² membrane electrode assemblies. FIG. 24 shows H₂/Air polarization curve at 90° C., 250 kPa, 40 RH for 50 cm² membrane electrode assemblies.

TABLE 6
Membrane electrode assembly voltage comparison at
fixed current densities between the control electrode
(no additive) and the electrode with either Mowital B
60 T or Mowital B 45 H powders. The % increase
column describes the performance improvement
imparted by these polymeric additives, in addition
to their crack-mitigating behavior.
80° C., 150 kPa, 100 RH H₂/Air polarization curves

| i (A/cm²) | V_{No additive} | V_{Additive} | % increase |
|---|---|---|---|
| 0.40 | 0.717 | 0.728 | 1.53 |
| 0.60 | 0.661 | 0.688 | 4.08 |
| 0.80 | 0.598 | 0.642 | 7.36 |
| 1.00 | 0.531 | 0.592 | 11.49 |
| 1.25 | 0.429 | 0.514 | 19.81 |
| 1.50 | 0.276 | 0.438 | 58.70 |

TABLE 7
Membrane electrode assembly voltage comparison at
fixed current densities between the control electrode
(no additive) and the electrode with either Mowital B
60 T or Mowital B 45 H powders. The % increase
column describes the performance improvement
imparted by these polymeric additives, in addition
to their crack-mitigating behavior.
90° C., 250 kPa, 40 RH H₂/Air polarization curves

| i (A/cm²) | V_{No additive} | V_{Additive} | % increase |
|---|---|---|---|
| 0.40 | 0.712 | 0.732 | 2.81 |
| 0.60 | 0.658 | 0.705 | 7.14 |
| 0.80 | 0.597 | 0.688 | 15.24 |
| 1.00 | 0.544 | 0.621 | 14.15 |
| 1.25 | 0.443 | 0.551 | 24.38 |

The described invention may be further understood by the following non-limiting examples:

Example 1. A catalyst ink comprising:
a solvent;
a catalyst;
an ionomer; and
a polymer additive, wherein the polymer additive decreases the formation of cracks in a catalyst layer when the catalyst ink forms the catalyst layer.

Example 2. The catalyst ink of claim 1, wherein the catalyst ink has a catalyst concentration greater than or equal to 2 wt % catalyst.

Example 3. The catalyst ink of claim 1 or 2, wherein the catalyst layer provides increased electrochemical performance over a catalyst layer without the polymer additive.

Example 4. The catalyst ink of claim 3, wherein the increased electrochemical performance is defined by a greater than 5% increase in E_{cell} at 1.5 A/cm² relative to a catalyst layer without a polymer additive.

Example 5. The catalyst ink of claim 3, wherein the increased electrochemical performance is defined by a greater than 10% increase in E_{cell} at 2 A/cm² relative to a catalyst layer without a polymer additive.

Example 6. The catalyst ink of any of claims 1-5, wherein the polymer additive has a wt % selected from the range of 3% to 10% relative to the ionomer mass.

Example 7. The catalyst ink of any of claims 1-6, wherein the polymer additive is selected from the group of: poly vinyl alcohol (PVA), poly vinyl butyral (PVB), poly acrylic acid (PAA), poly ethylene oxide (PEO), poly methyl methacrylate (PMMA), or a combination thereof.

Example 8. The catalyst ink of any of claims 1-7, wherein the polymer additive comprises PVA and the ionomer is a polyfluorosulfonic acid.

Example 9. The catalyst ink of any of claims 1-8, wherein the polymer additive comprises a copolymer of PVA and PVB and the ionomer is a polyfluorosulfonic acid.

Example 10. The catalyst ink of any of claims 1-9, wherein the catalyst comprises platinum.

Example 11. The catalyst ink of any of claims 1-10, wherein the catalyst layer is part of a membrane electrode assembly.

Example 12. The catalyst ink of claim 11, wherein the membrane electrode assembly is part of a polymer electrolyte membrane fuel cell.

Example 13. The catalyst ink of claim 12, wherein the polymer electrolyte membrane fuel cell is a hydrogen fuel cell.

Example 14. The catalyst ink of any of claims 1-13, wherein the catalyst layer has 50% fewer cracks relative to a catalyst layer formed without the polymer additive.

Example 15. The catalyst ink of any of claims 1-13, wherein the catalyst layer has 90% fewer cracks relative to a catalyst layer formed without the polymer additive.

Example 16. A method comprising:
providing a catalyst ink comprising:
a solvent;
a catalyst;
an ionomer; and
a polymer additive,
depositing the catalyst ink on gas diffusion media or a polymer exchange membrane; and
solidifying the catalyst ink thereby forming a catalyst layer on the gas diffusion media or polymer exchange membrane;
wherein the catalyst gas diffusion layer has reduced cracking due to the polymer additive.

Example 17. The method of claim 16, wherein the catalyst ink has a catalyst concentration greater than or equal to 2 wt % catalyst.

Example 18. The method of claim 16 or 17, wherein the polymer additive is selected from the group of: poly vinyl alcohol (PVA), poly vinyl butyral (PVB), poly acrylic acid (PAA), poly ethylene oxide (PEO), poly methyl methacrylate (PMMA), or a combination thereof.

Example 19. The method of any of claims 16-18, wherein the catalyst layer has 50% fewer cracks relative to a catalyst layer formed without the polymer additive.

Example 20. A device comprising:
an anode;
a cathode;
a polymer exchange membrane (PEM) positioned between the anode and the cathode;
at least one catalyst layer positioned between the anode and the PEM, the cathode and the PEM, or both;
wherein the catalyst layer comprises a polymer additive, wherein the polymer additive reduces the formation of cracks in the catalyst layer.

Example 21. The device of claim 20, wherein the catalyst layer provides increased electrochemical performance greater than or equal to a 5% increase in E_{cell} at 1.5 A/cm² over a catalyst layer without the polymer additive.

Example 22. The device of claim 20 or 21, wherein the polymer additive is selected from the group of: poly vinyl alcohol (PVA), poly vinyl butyral (PVB), poly acrylic acid (PAA), poly ethylene oxide (PEO), poly methyl methacrylate (PMMA), or a combination thereof.

Example 23. The device of any of claims 20-22, wherein the catalyst layer has 50% fewer cracks relative to a catalyst layer formed without the polymer additive.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, are disclosed separately. When a Markush group or other grouping is used herein, all individual members of the group and all combinations and subcombinations possible of the group are intended to be individually included in the disclosure. For example, when a device is set forth disclosing a range of materials, device components, and/or device configurations, the description is intended to include specific reference of each combination and/or variation corresponding to the disclosed range.

Every formulation or combination of components described or exemplified herein can be used to practice the invention, unless otherwise stated.

Whenever a range is given in the specification, for example, a density range, a number range, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter is claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A catalyst ink comprising:
a solvent;
a catalyst;
an ionomer; and
a polymer additive, wherein the polymer additive decreases the formation of cracks in a catalyst layer when the catalyst ink forms the catalyst layer.

2. The catalyst ink of claim 1, wherein the catalyst ink has a catalyst concentration greater than or equal to 2 wt % catalyst.

3. The catalyst ink of claim 1, wherein the catalyst layer provides increased electrochemical performance over a catalyst layer without the polymer additive.

4. The catalyst ink of claim 3, wherein the increased electrochemical performance is defined by a greater than 5% increase in E_{cell} at 1.5 A/cm² relative to a catalyst layer without a polymer additive.

5. The catalyst ink of claim 1, wherein the polymer additive has a wt % selected from the range of 3% to 10% relative to the ionomer mass.

6. The catalyst ink of claim 1, wherein the polymer additive is selected from the group of: poly vinyl alcohol (PVA), poly vinyl butyral (PVB), poly acrylic acid (PAA), poly ethylene oxide (PEO), poly methyl methacrylate (PMMA), or a combination thereof.

7. The catalyst ink of claim 1, wherein the polymer additive comprises PVA and the ionomer is a polyfluorosulfonic acid.

8. The catalyst ink of claim 1, wherein the polymer additive comprises a copolymer of PVA and PVB and the ionomer is a polyfluorosulfonic acid.

9. The catalyst ink of claim 1, wherein the catalyst comprises platinum.

10. The catalyst ink of claim 1, wherein the catalyst layer is part of a membrane electrode assembly.

11. The catalyst ink of claim 10, wherein the membrane electrode assembly is part of a polymer electrolyte membrane fuel cell.

12. The catalyst ink of claim 11, wherein the polymer electrolyte membrane fuel cell is a hydrogen fuel cell.

13. The catalyst ink of claim 1, wherein the catalyst layer has 50% fewer cracks relative to a catalyst layer formed without the polymer additive.

14. A method comprising:
providing a catalyst ink comprising:
a solvent;
a catalyst;
an ionomer; and
a polymer additive,
depositing the catalyst ink on gas diffusion media or a polymer exchange membrane; and
solidifying the catalyst ink thereby forming a catalyst layer on the gas diffusion media or the polymer exchange membrane;
wherein the catalyst layer has reduced cracking due to the polymer additive.

15. The method of claim 14, wherein the catalyst ink has a catalyst concentration greater than or equal to 2 wt % catalyst.

16. The method of claim 14, wherein the polymer additive is selected from the group of: poly vinyl alcohol (PVA), poly vinyl butyral (PVB), poly acrylic acid (PAA), poly ethylene oxide (PEO), poly methyl methacrylate (PMMA), or a combination thereof.

17. The method of claim 14, wherein the catalyst layer has 50% fewer cracks relative to a catalyst layer formed without the polymer additive.

18. A device comprising:
an anode;
a cathode;
a polymer exchange membrane (PEM) positioned between the anode and the cathode;
at least one catalyst layer positioned between the anode and the PEM, the cathode and the PEM, or both;
wherein the catalyst layer comprises a polymer additive, wherein the polymer additive reduces the formation of cracks in the catalyst layer.

19. The device of claim 18, wherein the catalyst layer provides increased electrochemical performance greater than or equal to a 5% increase in E_{cell} at 1.5 A/cm² over a catalyst layer without the polymer additive.

20. The device of claim 18, wherein the polymer additive is selected from the group of: poly vinyl alcohol (PVA), poly vinyl butyral (PVB), poly acrylic acid (PAA), poly ethylene oxide (PEO), poly methyl methacrylate (PMMA), or a combination thereof.
